(19) United States
(12) Patent Application Publication
(10) Pub. No.: US 2024/0199384 A1
(43) Pub. Date: Jun. 20, 2024

(54) WORKING CRANE CONTROL SYSTEM TO REDUCE THE ENVIRONMENTAL IMPACT OF VARIABLE SPEED DRIVES

(71) Applicant: MANITOWOC CRANE GROUP FRANCE, DARDILLY (FR)

(72) Inventor: Bruno RONI-DAMOND, LYON (FR)

(21) Appl. No.: 18/542,591

(22) Filed: Dec. 15, 2023

(30) Foreign Application Priority Data
Dec. 16, 2022 (FR) 2213594

(51) Int. Cl. B66C 13/23; B66C 13/30; B66C 13/40; B66C 23/88

(52) U.S. Cl. CPC B66C 13/23; B66C 13/30; B66C 13/40; B66C 23/88; B66C 23/022

(57) ABSTRACT

A piloting system for piloting a crane in work, including at least: a piloting interface, a control-command system connected to the piloting interface, work actuators ensuring the displacements of the load, and variable-speed drives connected to the control-command system and to the work actuators to receive piloting commands originating from the control-command system and to transmit to the work actuators speed setpoints. At least one amongst the variable-speed drives, referred to as the common variable-speed drive, is connected to at least two work actuators, referred to as the shared actuators, by a distribution relay, so that the common variable-speed drive alternately pilots each of the shared actuators.

### FIELD

The present disclosure relates to a system for piloting a crane.

More particularly, the present disclosure relates to a system for piloting a crane in work falling in an eco-design approach, for which the use of electric actuators and variable-speed drives implementing the different movements of the crane is as energy-efficient and low-polluting as possible.

The present disclosure also relates to a crane comprising the aforementioned piloting system.

The present disclosure also relates to a piloting method implemented by piloting a crane in work.

The subject matter of the present disclosure finds a non-limiting application for a plurality of crane types, for example: top-slewing cranes, self-erecting cranes, luffing cranes, and/or cranes movable in translation on a rail.

### BACKGROUND

In a known manner, the loads are hoisted and displaced by the cranes by means of electric work actuators piloted by the crane operator from a piloting interface present in the driver cabin or on a radio-control or any remote control station; such a piloting interface could be in the form of a control joystick and/or buttons.

In the field of cranes, the work actuators conventionally comprise a hoisting winch which is intended to hoist and descend the load vertically; a dispensing winch which is intended to dispense the charge along a dispenser jib, by displacing a dispenser carriage; a steering actuator which is intended to steer a jib about a vertical axis; a luffing actuator which is intended to luff or lower a jib angularly for a luffing crane; a translational actuator which is intended to make the crane translate on a rail for a crane movable in translation; etc.

To each type of displacement movement of the load (hoisting, dispensing, steering, luffing, translation, etc.), an electric motor, so-called later on the work actuator, is necessary for completion thereof.

The at least one work actuator implementing a movement amongst the several movements that the crane can perform is commonly connected to a variable-speed drive (also called variable-frequency drive) configured to regulate the speed of the electric motor of the work actuator to control the movement, manage the consumed energy, reduce the mechanical stress on the control applications of the motors, etc. The variable-speed drive is also connected to the control-command system of the crane which is, in turn, connected to the piloting interface. Thus, when the crane operator uses the piloting interface in order to implement a movement according to a given speed, the latter generates piloting signals which are sent to the control-command system which will translate them into piloting commands. Afterwards, these piloting commands are sent to the variable-speed drives by the control-command system. Depending on these, the variable-speed drive transmits speed setpoints to the at least one work actuator so that it performs the movement at the desired speed.

Thus, a variable-speed drive is associated with each crane movement. The variable-speed drives, and by extension the movements, are therefore independent in terms of piloting from each other. In general, the operation of the cranes is designed so that the crane operator could simultaneously perform all movements, to the extent that this simultaneity is possible and/or authorized. For example, the hoisting, steering and dispensing movements may be forbidden during a translation.

However, nowadays, companies have to positively comply with new regulations to initiate their ecological transition and put sustainable development behaviors into practice, in order to bring in a global and sustainable solution to the major environmental concerns of this century. The ecological transition aims to put in place an economic, social development model that is resilient and sustainable which positively rethinks the way of consuming, producing, working and living together, in particular in the areas of energy consumption and polluting emissions reduction.

Variable-speed drives are electric/electronic systems comprising power electronics, control electronics, mechanical members for cooling, motors of the electromechanical components, etc. Yet, some of the components or subsystems included in variable-speed drives require manufacture thereof with rare and/or very polluting materials, which materials may also be treated or shaped by means of compounds that are also polluting or ecologically controversial. For example, additives are introduced in some used materials such as flame-retardants which might be harmful to health. Moreover, the components of variable-speed drives are generally rarely reconditioned/recycled, and difficult to repair in the event of a malfunction or a breakdown.

This is why the use of a plurality of variable-speed drives in the operation of a crane tends to become incompatible with increasingly drastic environmental regulations, and with a desire to reduce the ecological impact of cranes widely used in the construction field.

### SUMMARY

The present disclosure aims to address the problem set out hereinabove by providing a piloting solution for the implementation of the movements of a crane which is more ecological, in particular by being more energy-efficient and less polluting, and more ecological than current piloting solutions; and that being so for comparable operating performances.

The present disclosure relates to a piloting system for piloting a crane in work, comprising at least:
a piloting interface to enable a crane operator to pilot displacement movements of a load by the crane;
a control-command system connected to the piloting interface to receive piloting signals originating from the piloting interface and generate piloting commands according to said piloting signals;
work actuators ensuring the displacement movements of the load;
variable-speed drives which are connected to the control-command system and to the work actuators to receive the piloting commands originating from the control-command system and transmit to the work actuators speed setpoints according to the piloting commands.

This piloting system is remarkable in that at least one amongst the variable-speed drives, so-called the common variable-speed drive, is connected to at least two work actuators, so-called the shared actuators, amongst the work actuators, via a distribution relay, said distribution relay being piloted so as to alternately connect the common variable-speed drive with each of the at least two shared actuators, so that the at least two shared actuators function alternately.

In other words, the present disclosure proposes associating two distinct displacement movements that can be performed by a crane when it is in work, and therefore associating the two work actuators each responsible for one of the two movements, with one single variable-speed drive. As indicated hereinabove, the work actuators in charge of the two displacement movements are referred to as shared actuators, and the variable-speed drive connected to these two shared actuators is referred to as a common variable-speed drive.

The connection of two shared actuators to the common variable-speed drive implies that the two displacement movements cannot be performed simultaneously but alternately. In particular, this alternation is ensured by the distribution relay. Consequently, the crane operator should complete one amongst the two movements if he wishes to start the other one amongst the two movements.

In an embodiment according to the present disclosure, following the end of the first displacement movement (which is detected by equipment of the crane like sensors, and/or by the control-command system), the crane operator will have to wait for a predefined short time period (for example, for a few seconds) to start the second displacement movement. For the crane operator to be informed that the time period has elapsed, it may be considered that the piloting interface informs him by means of a text message or a visual indication displayed on a screen, and/or an audible signal.

In a second embodiment according to the present disclosure, the distribution relay is controlled by the control-command system. Depending on the piloting signal received by the control-command system, which is representative of one of the two displacement movements that the crane operator wishes to perform, the distribution relay connects the output of the common variable-speed drive the to the input of the shared actuator in charge of said displacement movement; so that the common variable-speed drive the supplies it with the necessary power for the completion of the displacement movement at the desired speed. Thus, the common variable-speed drive is not electrically connected via the distribution relay to the shared actuator in charge of the other one amongst the two movements.

In a third embodiment according to the present disclosure, in an application context where the speeds of the displacement movements should be rigorously accurate, speed measuring devices present on the crane, like sensors, are configured to measure said speeds when performing the two displacement movements and then transmit the measured speeds to the common variable-speed drive. The common variable-speed drive then compares the measured speed values to the speed setpoints contained in the piloting command; supplying more (respectively less) power to the shared actuators depending on whether the measured speeds are lower (respectively higher) than the speed setpoints. In a variant according to the present disclosure, once the speed measurements are received, the common variable-speed drive transmits these to the control-command system which will compare them to the piloting signals sent by the piloting interface. Depending on the comparison results, the control-command system adapts, or not, the piloting command transmitted to the common variable-speed drive for piloting the shared actuators. In a variant according to the present disclosure, it may be considered that the speeds measured by the sensors are transmitted directly to the control-command system.

In a fourth embodiment according to the present disclosure, in order to regulate the speed of a displacement movement, it may be considered to equip the crane with at least one brake associated with at least one amongst the work actuators, which brake is piloted in two variants of the present embodiments either by a variable-speed drive, or by the control-command system. It is also possible to consider the brake communicating its state (open brake or closed brake) to the variable-speed drive or to the control-command system.

The first advantage of the proposed solution is to positively fit into an eco-design approach promoting sustainable development.

By using one single variable-speed drive instead of two for the implementation of two displacement movements of a crane in work, this therefore means that it is necessary to manufacture only one variable-speed drive. For variable-speed drive manufacturers, this amount to reducing by half the number of resources used during the manufacturing step, whether this concerns a components that is difficult to recondition and/or recycle; materials that could be rare and polluting, hazardous additives, etc.

The present embodiments are also more energy-efficient since one single variable-speed drive has to be powered to function.

Moreover, it is possible to equip the crane with several common variable-speed drives, since, depending on the crane type, it is possible to group together two displacement movements. Two movements that are generally never performed in parallel, but successively, may be grouped together. For example, the hoisting, steering, or dispensing movements are generally forbidden during a translational movement.

Thus, and advantageously, the proposed embodiments in accordance with the present disclosure allow reducing the environmental impact of the variable-speed drives, and by extension of the crane, at many levels, whether: with regards to the application context on the construction site; or with regards to the circulation and exploitation of resources that are non-recyclable, and/or polluting, and/or potentially harmful to health.

The second advantage of the present embodiments is economic, since by reducing the number of variable-speed drives, the manufacturing cost of a crane decreases (this decrease could also concern the purchase price of the crane).

Finally, a last advantage of the present embodiments is that the suppression of a variable-speed drive to associate two actuators with a common variable-speed drive does not result in a degradation of the operating performances of the crane in terms of load displacement; since, as indicated before, the two displacement movements, which are grouped together, correspond to movements that are generally performed successively.

According to a feature of the present embodiments, the distribution relay is piloted by the common variable-speed drive which is designed so as to send to said distribution relay distribution setpoints according to the piloting commands originating from the control-command system.

In other words, switching the distribution relay to connect the common variable-speed drive to either one of the two shared actuators is piloted by the common variable-speed drive itself. Depending on the piloting command received thereby, the common variable-speed drive sends a distribution setpoint to the distribution relay so that it switches from one shared actuator to another, or it remains in its current switch configuration.

According to a feature of the present embodiments, the control-command system is designed so as to transmit to the piloting interface an alert message intended to the crane operator when said crane operator acts on the piloting interface in order to pilot two movements at the same time associated to shared actuators that can function only alternately.

In the case where the crane operator attempts to implement the two displacement movements associated with the shared actuators, the piloting interface displays an error message emitted by the control-command system and the action of the crane operator is neutralized, that is to say none of the two movements is started upon such an attempt.

In the embodiment where a time period is provided for between the end of the execution of the first displacement movement and the start of the second displacement movement, the control-command system emits an error message in the case where the crane operator attempts to start the second movement during this time period. Thus, a strumming of the crane operator, that is to say piloting by alternately imparting an impulse on the controls piloting two displacement movements, is automatically detected and then neutralized.

According to a feature of the present embodiments, the work actuators comprise a hoisting actuator associated with a hoisting movement, a steering actuator associated with a steering movement and a dispensing actuator associated with a dispense movement for the crane which is of the jib crane type, and the at least two shared actuators comprise the hoisting actuator and the steering actuator in a first configuration, or the at least two shared actuators comprise the hoisting actuator and the dispensing actuator in a second configuration.

According to a feature of the present embodiments, the dispensing actuator is connected to another variable-speed drive, amongst the variable-speed drives, distinct from the common variable-speed drive in the first configuration, or the steering actuator is connected to another variable-speed drive, amongst the variable-speed drives distinct from the common variable-speed drive in the second configuration.

According to a feature of the present embodiments, the piloting system is such that:
in the first configuration: the other variable-speed drive, so-called the other common variable-speed drive, is connected to a translational actuator associated with a translational movement and to the dispensing actuator via another distribution relay, said other distribution relay being piloted so as to alternately connect the other common variable-speed drive with the translational actuator and the dispensing actuator, so that the translational actuator and the dispensing actuator function alternately; or
in the second configuration: the other variable-speed drive, so called the other common variable-speed drive, is connected to a translational actuator associated with a translational movement and to the steering actuator via another distribution relay, said other distribution relay being piloted so as to alternately connect the other common variable-speed drive with the translational actuator and the steering actuator, so that the translational actuator and the steering actuator function alternately.

The two displacement movements related to the common variable-speed drive are ergonomically selected so as to preserve, or at least approach, the same operating performances of the crane for the displacement of a load, i.e. to preserve a fluid/dynamic piloting of the crane, following the suppression of a variable-speed drive related to one of the two displacement movements.

As indicated before, the two displacement movements that are grouped together consist of displacement movements that are generally carried out successively. For example, the hoisting, steering, and dispensing movements are generally forbidden during a translational movement. Indeed, piloting of a crane is most often done in two dimensions: vertically to hoist the load; and according to a horizontal plane to dispense and steer the jib to displace the load in the work area of the crane. This is why the translational movement could be grouped with each of these three movements. In other words, in different embodiments, one amongst the two shared actuators may correspond to a translational actuator, whereas the other shared actuator may correspond to a hoisting actuator, or a steering actuator, or a dispensing actuator.

Jib cranes integrate the mentioned four actuator types. In two different embodiments, referred to hereinabove as the first configuration and second configuration, it is possible, for this crane type, to group together the four displacement movements (and therefore the four actuators implementing them) into two groups, provided that two common variable-speed drives are used for each of the two configurations.

The two configurations are established according to a tradeoff between:
operational performance objectives, for example in terms of speed or weight of loads that could be hoisted and displaced; and
safety objectives, in particular for limiting the risks of overload and for controlling dangling of the jib crane during the displacement of the load. The actual performances of the control-command system may also be considered.

The first configuration pertains to an application context of minimizing the risks of overload and poor control of dangling even if it means that the functional performances of the jib crane are not exploited to their full. For the latter, the common variable-speed drive is alternately connected to the steering actuator and to the hoisting actuator, while the other common variable-speed drive is alternately connected to the dispensing actuator and to the translational actuator. Thus, in the event of a momentary overload and/or swinging of the load during the displacement of the latter, the crane operator is still mastering the piloting of the jib crane, by being capable of bringing the dispensing winch towards the mast while lowering the load vertically, as he can act simultaneously on the dispensing actuator and on the hoisting actuator.

The second configuration favors the operational performances of the crane, with a crane operator capable of piloting it until reaching the operating limit authorized by the safety standards. In this second configuration, the common variable-speed drive is alternately connected to the steering actuator or to the translational actuator; and the other common variable-speed drive is alternately connected to the dispensing actuator or to the hoisting actuator. Thus, the crane operator can displace a load in the horizontal plane whose weight is equal to the limit imposed by the manufacturer of the crane and authorized by the torque/moment limiter, because he can act simultaneously on the steering actuator and on the dispensing actuator.

It should be noted that, advantageously, the implementation of the two configurations requires using only two variable-speed drives, instead of the conventional four.

According to one feature, the work actuators comprise a hoisting actuator associated with a hoisting movement, a steering actuator associated with a steering movement and a jib luffing actuator associated with a jib luffing movement for the crane which is of the jib crane type, and the at least two shared actuators comprise the hoisting actuator and the steering actuator.

According to one feature, the jib luffing actuator is connected to another variable-speed drive, amongst the variable-speed drives, distinct from the common variable-speed drive.

According to one feature, the other variable-speed drive, so-called the other common variable-speed drive, is connected to a translational actuator associated with a translational movement and to the jib luffing actuator via another distribution relay, said other distribution relay being piloted so as to alternately connect the other common variable-speed drive with the translational actuator and the jib luffing actuator, so that the translational actuator and the jib luffing actuator function alternately.

In a known manner, luffing cranes (with the jib that could be articulated or not) are characterized in that they have no dispenser carriage. The hoisting rope is always at the jib tip, and the counter-jib is shorter than that of a jib crane; which allows installing and mounting this crane type proximate to an obstacle.

Luffing cranes comprise at least one hoisting actuator, one steering actuator, one jib luffing actuator, and one translational actuator. The crane is luffed (respectively lowered) to hoist the load and bring it close to (respectively away from) the mast. Hence, when they pilot this crane type, the crane operators should compensate for the rise or descent of the load upon inclination of the jib to change the dispense radius.

For this crane type, in an embodiment in accordance with the present disclosure, the common variable-speed drive is alternately connected to the steering actuator or to the hoisting actuator, and the other common variable-speed drive is alternately connected to the luffing actuator or to the translational actuator.

This is the only possible configuration offering a good tradeoff in terms of operational performances and safety, because the crane operator is capable of adjusting the load by simultaneously performing a hoisting movement and a luffing movement. By acting simultaneously on the hoisting actuator and on the jib luffing actuator, the crane operator can therefore pilot in the horizontal plane by combining these two movements.

Herein again, the implementation of this configuration allows using two variable-speed drives instead of four.

Possibly, in the case where the weight of the load is close to the load limit imposed by the manufacturer of the crane, and in order to safeguard piloting of the latter, it may be considered, in a variant of the present embodiments, to connect the hoisting actuator and the jib luffing actuator together to a common variable-speed drive, and therefore group together the two most aggravating/risky movements.

The present disclosure also relates to a crane comprising a piloting system as described before.

The present disclosure also relates to a piloting method for piloting a crane in work, comprising at least:
a piloting step in which a crane operator pilots displacement movements of a load by the crane on a piloting interface;
a step of receiving piloting signals originating from the piloting interface by a control-command system connected to the piloting interface;
a step of generating by the control-command system piloting commands according to said piloting signals;
a step of transmitting the piloting commands to variable-speed drives which are connected to the control-command system and to work actuators ensuring the displacement movements of the load;
a control step in which the variable-speed drives transmit to the work actuators speed setpoints according to the piloting commands;
the piloting method being remarkable in that at least one amongst the variable-speed drives said common variable-speed drive, is connected to at least two work actuators, so-called the shared actuators, among the work actuators, via a distribution relay, and in that it comprises a switching step in which said distribution relay is piloted so as to alternately connect the common variable-speed drive with each of the at least two shared actuators, so that the at least two shared actuators function alternately.

### BRIEF DESCRIPTION OF THE DRAWINGS

Other features and advantages of the present invention will appear upon reading the detailed description hereinafter, of a non-limiting example of implementation, made with reference to the appended figures wherein:

FIG. 1 is a simplified schematic view of a jib crane according to an embodiment of the present disclosure;

FIG. 2 is a simplified schematic view of a luffing crane according to an embodiment;

FIG. 3 is a schematic view illustrating a first example of a piloting system for which the output of the control-command system is connected to a conventional variable-speed drive piloting a work actuator, and to a common variable-speed drive alternately piloting two work actuators via a distribution relay;

FIG. 4 is a schematic view illustrating a second example of a piloting system for which the output of the control-command system is connected to a common variable-speed drive piloting two shared via a distribution relay, and to another common variable-speed drive itself alternately piloting two shared actuators via another distribution relay;

FIG. 5 is a schematic view equivalent to FIG. 4 when the piloting system is integrated to a jib crane, and for which the shared actuators correspond to a translational actuator, a steering actuator, a hoisting actuator, and to a dispensing actuator, with the four shared actuators grouped together into groups of two connected to a common variable-speed drive such that the two groups fit into a safety approach in particular with a minimization of the risks of overloading the jib crane;

FIG. 6 is a schematic view equivalent to FIGS. 4 and 5, for which the two groups of shared actuators fit into an approach optimizing the performances of the jib crane; and

FIG. 7 is a schematic view equivalent to FIG. 4 when the piloting system is integrated to a luffing crane, and for which the mutualized actuators correspond to a translational actuator, a steering actuator, a hoisting actuator, and to a jib luffing actuator, with the four shared actuators grouped into groups of two connected to a common variable-speed drive such that the two groups pertains to an approach of tradeoff between operational performance and safety.

### DESCRIPTION

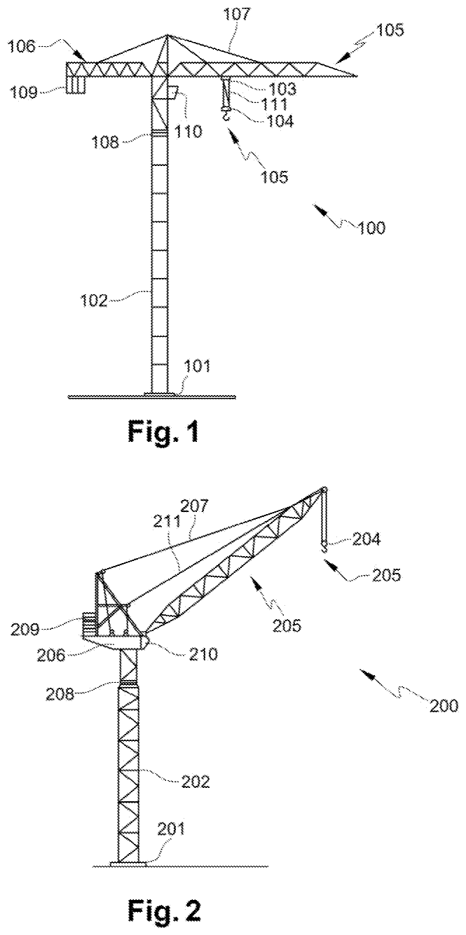

The piloting system 1 proposed by the embodiments according to the present disclosure may be considered for a jib crane 100 and also a luffing crane 200, simplified diagrams of which are respectively illustrated in FIGS. 1 and 2.

Each of the two cranes 100, 200 comprises a mast 102, 202; and a rotary assembly rotatable about a steering axis, which extends vertically, by means of a turntable 108, 208 coupled to at least one steering motor, belonging to the rotary assembly covers a circular area about the steering axis.

The rotary assembly of a jib crane 100 is formed by a jib 105 and a counter-jib 106 substantially aligned, and possibly a head (or apex) with tie bars 107.

The rotary set of a luffing crane 200 is formed by a jib 205 which is lowered and luffed angularly by means of at least one luffing rope 207, and by a base 206 on which the jib 205 is pivotally mounted. According to different designs of a luffing crane 200, the jib 205 may be composed, or not, of articulated jib elements.

For both crane types 100, 200, a counterweight 109, 209 (or ballast weight) is used to counterbalance the weight of a load hoisted by the crane 100, 200 and to balance the latter during steering movements thereof. In the jib crane 100, the counterweight 109 is carried by the counter-jib 106, and in the luffing crane 200, the counterweight 209 is carried by the base 206.

The load is hoisted by means of a hook 105, 205 located at the end of a reeve block 104, 204 which is displaced vertically by means of at least one hoisting rope 111, 211.

In a jib crane 100, the hoisting rope 111 hangs to a dispenser carriage 103 movable in translation on a rolling track provided along the jib 105.

Luffing cranes 200 do not have a dispenser carriage. The load is hoisted according to the inclination of the jib 205 and therefore the winding or unwinding of the luffing rope 207.

As indicated before, each of the displacement movements of a load that could be performed by a crane 100, 200 is implemented by a dedicated electric work actuator. The work actuators conventionally comprise:
a hoist winch coupled to the hoisting rope and which is intended to hoist and lower the load vertically, namely a hoisting actuator;
a steering actuator coupled to the turntable 108, 208 and intended to steer the rotary assembly about the steering axis;
a translational actuator which is intended to make the crane 100, 200 translate on a rail in the case where the crane is intended to be movable in its entirety on the rail;
for jib cranes 100, a dispensing winch coupled to a dispensing rope fastened to the dispenser carriage 103 and which is intended to dispense the load along the jib 105 by means of the dispenser carriage 103, namely a dispensing actuator;
for luffing jibs 200, a jib luffing actuator coupled to the luffing rope 207 and which is intended to angularly luff or lower the jib 205.

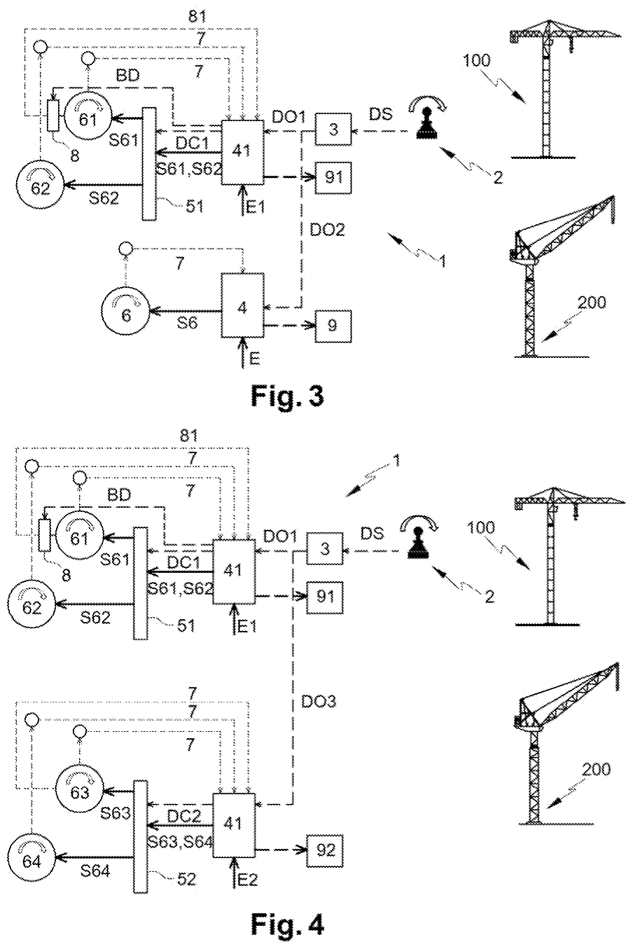

Referring to FIGS. 3 and 4, each of the work actuators, which bear the references 6, 61, 62, 63 and 64 in these figures, is connected to a variable-speed drive 4, 41, 42 intended to regulate, according to speed setpoints S6, S61, S62, S63, S64, the speed of the electric motor of the work actuator 6, 61, 62, 63, 64 in order to control the movement, manage the consumed energy, reduce the mechanical stress on the control applications of the motors, etc.

Referring to FIGS. 3-7, the piloting system 1 of the present embodiments comprises several elements/components contributing to the implementation of a piloting method.

First of all, the piloting system 1 comprises a piloting interface 2 to enable a crane operator during a piloting step of piloting displacement movements of a load that could be performed by the crane 100, 200. According to different design modes of the cranes 100, 200, the piloting interface 2 may be installed in a driver cabin 110, 210 of the crane 100, 200 (in the form of a control monitor/dashboard with screens), or be in the form of a radio-control or a remote control station. In any case, it comprises at least one control joystick and buttons.

When the crane operator interacts with the piloting interface 2 to perform a movement, the piloting interface 2 generates piloting signals DS which are received during a reception step by a control-command system 3 which is physically connected and/or which is in communication with the piloting interface 2.

Based on the piloting signals DS, the control-command system 3 generates during a step of generating the piloting commands DO1, DO2, DO3. The, it transmits afterwards, during a step of transmission, the piloting commands DO1, DO2, DO3 to variable-speed drives 4, 41, 42 so that they pilot the work actuators 6, 61, 62, 63, 64 for the implementation of the displacement movement(s) of the load desired by the crane operator. Depending on the nature of the piloting signals DS representative of the displacement movement(s) to be performed, the variable-speed drives 4, 41, 42 receive, or not, the piloting commands DO1, DO2, DO3 emitted by the control-command system 3 depending on whether they pilot, or not, the work actuators 6, 61, 62, 63, 64 in charge of the movement.

Referring to FIGS. 3 and 4, two application context general examples are illustrated.

In the application context of FIG. 3, the piloting system 1 comprises:
three work actuators 6, 61, 62, namely a first work actuator 61, a second work actuator 62 and a third work actuator 6;
two variable-speed drives 4, 41, namely a first variable-speed drive 41 and a second variable-speed drive 4.

The first variable-speed drive 41 is connected to the first work actuator 61 and to the second work actuator 62 via a distribution relay 51; the first work actuator 61 and the second work actuator 62 thus constitute shared actuators, to the extent that they are connected to the same first variable-speed drive 41, so-called the common variable-speed drive. In turn, the second variable-speed drive 4 is connected only to the third actuator 6.

Thus, the control-command system 3 is connected to these two variable-speed drives 4, 41 respectively receiving piloting commands DO1, DO2 such that the second variable-speed drive 4 is connected and pilots only the third work actuator 6, and the first variable-speed drive 41, or common variable-speed drive, pilots the two shared actuators 61, 62.

In the application context of FIG. 4, the piloting system 1 comprises:
four work actuators 61, 62, 63, 64, namely a first work actuator 61, a second work actuator 62, a third work actuator 63 and a fourth work actuator 64;
two variable-speed drives 41, 42, namely a first variable-speed drive 41 and a second variable-speed drive 42.

The first variable-speed drive 41 is connected to the first work actuator 61 and to the second work actuator 62 via a first distribution relay 51; the first work actuator 61 and the second work actuator 62 thus constitute shared actuators, to the extent that they are connected to the same variable-speed drive 41, so-called the common variable-speed drive.

The second variable-speed drive 42 is connected to the third work actuator 63 and to the fourth work actuator 64 via a second distribution relay 52, also called the other distribution relay; the third work actuator 63 and the fourth work actuator 64 thus constitute other shared actuators, to the extent that they are connected to the same variable-speed drive 42, so called the other common variable-speed drive.

Thus, the control-command system 3 is connected to these two variable-speed drives 41, 42 respectively receiving piloting commands DO1, DO3 such that the first variable-speed drive 41, or common variable-speed drive, pilots the two shared actuators 61, 62, and the second variable-speed drive 42, so-called the other common variable-speed drive, pilots the two shared actuators 63, 64.

Each of the variable-speed drives 4, 41, 42 receives an electric power E, E1, E2 originating from an electric power grid. Possibly, and as illustrated in FIG. 3 and FIG. 4, the variable-speed drives 4, 41, 42 may be coupled to energy dissipation devices in order to avoid any overheat of the variable-speed drives 4, 41, 42.

The two application contexts illustrated in FIGS. 3 and 4 are not exhaustive/limiting. Depending on the needs, that is to say the number of displacement movements to be executed, the piloting system 1 may comprise more work actuators 6; 61, 62; 63, 64 and variable-speed drives 4; 41; 42 (whether these consist of variable-speed drives 4 connected to one single work actuator 6 or common variable-speed drives 41, 42 connected to two shared actuators 61, 62, 63, 64).

Thus, it is possible to equip a crane 100; 200 with several common variable-speed drives 41; 42, since, depending on the crane type 100; 200, it is possible to group together two displacement movements to be performed alternately (and therefore not simultaneously).

In concept, the two movements implemented by the two shared actuators 61, 62 connected to the common variable-speed drive 41 cannot be performed simultaneously but alternately. In particular, this alternation is ensured by means of a distribution relay 51. Consequently, the crane operator should complete one amongst the two movements (for example that one associated with the first work actuator 61) if he wishes to start the other one amongst the two movements (for example that one associated with the second work actuator 62). The same applies to the two movements implemented by the two other shared actuators 63, 64 connected to the other common variable-speed drive 42; the alternation of which is ensured by means of the other distribution relay 52.

In the case where the crane operator attempts to implement the two displacement movements associated with the shared actuators 61, 62, 63, 64 of the same common variable-speed drive 41, 42 simultaneously, the piloting interface 2 displays an error message emitted by the control-command system 3 and the action of the crane operator is neutralized, that is to say none of the two movements is started upon his attempt. Thus, a strumming of the crane operator, that is to say piloting by alternately imparting an impulse on the controls piloting two displacement movements, is automatically detected and then neutralized.

Each of the distribution relays 51, 52 features two switch configurations which are:
a first switch configuration in which the distribution relay 51, 52 connects the common variable-speed drive 41, 42 to a first one amongst the two shared actuators 61, 62, 63, 64 (for example, the first work actuator 61 and the third work actuator 63) piloted thereby, and cut offs the link with a second one amongst the two shared actuators 61, 62, 63, 64 (for example, the second work actuator 62 and the fourth work actuator 64) which it cannot therefore pilot; and
a second switch configuration in which the distribution relay 51, 52 connects the common variable-speed drive 41, 42 to the second one amongst the two shared variable-speed drives 61, 62, 63, 64 (for example, the second work actuator 62 and the fourth work actuator 64) piloted thereby, and cuts off the link with the first one amongst the two shared actuators 61, 62, 63, 64 (for example the first work actuator 61 and the third work actuator 63) which it cannot therefore pilot.

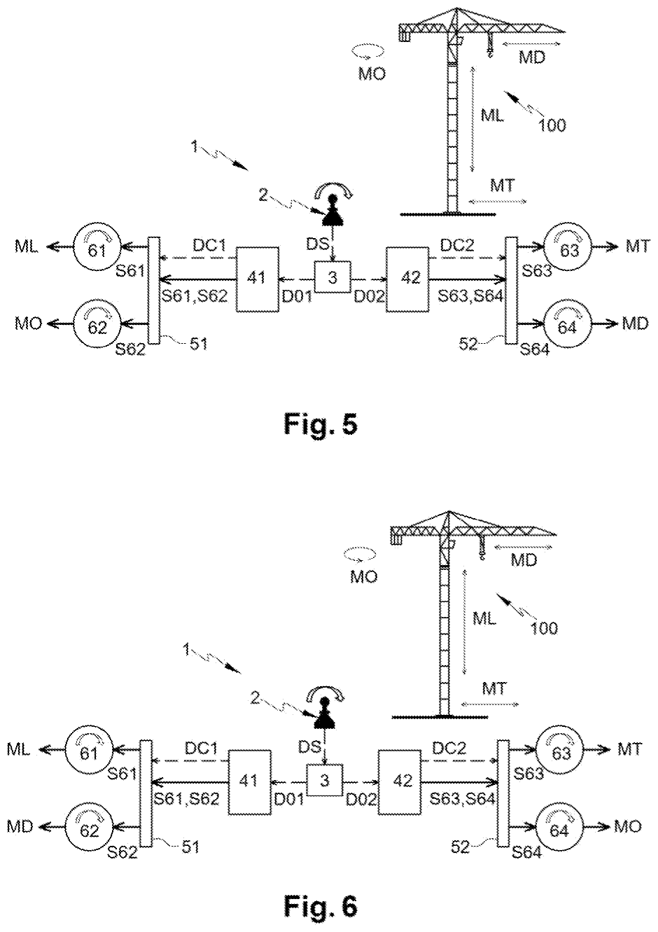

Referring to FIGS. 4 and 5, when the variable-speed drive 4 receives the piloting command DO2 associated thereto originating from the control-command system 3, it transmits afterwards, during a control step, a speed setpoint S6 to the work actuator 6 so that the movement implemented thereby is performed at a given speed.

Depending on the movement that should be implemented by one of the two shared actuators 61, 62 (or 63, 64), the common variable-speed drive 41 (or the other common variable-speed drive 42) sends to the distribution relay 51 (or to the other distribution relay 52), during the control step, in addition to the speed setpoint S61, S62 (or S63, S64), a distribution setpoint DC1 (or DC2). Depending on this distribution setpoint DC1 (or DC2), the distribution relay 51 (or the other distribution relay 52) remains in its current switch configuration or change the switch configuration, so that the speed setpoint S61 or S62 (or S63 or S64) is transmitted to the shared actuator 61 or 62 considered (or 63 or 64 considered) for the implementation of the desired movement.

In an embodiment where the crane operator wishes to perform a first movement associated with a first one amongst the two shared actuators 61, 62, 63, 64, then a second movement associated with the second one amongst the two shared actuators 61, 62, 63, 64, following the end of the first movement (which is estimated by the control-command system 3, and possibly confirmed by equipment of the crane 100; 200 like sensors), the crane operator will have to wait for a predefined short time period (for example, for a few seconds) to start the second movement. In the case where the crane operator attempts to start the second movement during this time period, the control-command system 3 emits an error message. For the crane operator to be informed that the time period has elapsed, it may be considered that the piloting interface 2 informs him by means of a text message or a visual indication displayed on a screen, and/or an audible signal.

In a second embodiment, the distribution relay 51 and the other distribution relay 52 are controlled by the control-command system 3. Depending on the piloting signal DS received by the control-command system 3, which is representative of one of the two displacement movements that the crane operator wishes to perform, the distribution relay 51 and the other distribution relay 52 connect the output of the common variable-speed drive 41 and of the other common variable-speed drive 42 to the input of the shared actuator 61, 62; 63, 64 in charge of said displacement movement; so that the common variable-speed drive 41 and the other common variable-speed drive 42 supplies to the shared actuator 61, 62; 63, 64 to which each of them is connected the power necessary for the completion of the displacement movement at the desired speed.

In a third embodiment, in an application context where the speeds of the displacement movements should be rigorously accurate, servo-control feedbacks 7 may be implemented, for example with speed measuring devices present on the crane 100; 200, like sensors, which are configured to measure said speeds (for example the speeds of the movements and/or the speeds of the work actuators) when performing the displacement movements and then transmit the measured speeds to the variable-speed drives 4; 41; 42.

The variable-speed drives 4; 41; 42 then compare the measured speed values to the speed setpoints S6; S61, S62; S63, S64 contained in the piloting command; supplying more (respectively less) power depending on whether the measured speeds are lower (respectively higher) than the speed setpoints S6; S61, S62; S63, S64 to the work actuators 6; 61, 62; 63, 64. In a variant of the present embodiments, once the speed measurements are received, the variable-speed drives 4; 41; 42 transmit these to the control-command system 3 which will compare them to the piloting signals DS sent by the piloting interface 2. Depending on the comparison results, the control-command system 3 adapts, or not, the piloting command DO1; DO2; DO3 transmitted to the variable-speed drives 4; 41; 42 for piloting the work actuators 6; 61, 62; 63, 64. In a variant of the present embodiments, it may be considered that the speeds measured by the sensors are transmitted directly to the control-command system 3.

In a fourth embodiment according to the present disclosure, in order to regulate the speed of the displacement movements, it may be considered that at least one amongst the work actuators 6; 61, 62; 63, 64 of the crane 100; 200 is coupled with a brake 8 (which is the case for example of the steering actuator), which brake is piloted in two variants of the present embodiments:
either by the variable-speed drive 4; 41; 42, which sends a brake command BD to the brake 8,
or by the control-command system 3 itself.

In the examples shown in FIGS. 3 and 4, a brake 8 is coupled with the first work actuator 61 connected to the common variable-speed drive 41. For the speed of a displacement movement to be regulated, it is also possible to consider the brake 8 communicating its state 81 (open brake or closed brake) to the common variable-speed drive 41 connected to the first work actuator 61 to which it is coupled, or else to the control system 3.

As indicated before, the work actuators 6; 61, 62; 63, 64 may, in particular, comprise: a hoisting actuator associated with a hoisting movement ML; a steering actuator associated with a steering movement MO; a translational actuator associated with a translational movement MT; a dispensing actuator associated with a dispensing movement MD if the crane is a jib crane 100; or a jib luffing actuator associated with a jib luffing movement MR if the crane is a luffing crane 200.

As explained so far, a common variable-speed drive 41 (or 42) alternately pilots two shared actuators 61, 62 (or 63, 64) each implementing a displacement movement.

Referring to FIGS. 4-7, in the case where the piloting system 1 comprises several common variable-speed drives 41, 42, the displacement movements (and therefore the shared actuators 61, 62, 63, 64 implementing them) related to these are ergonomically selected so as to preserve, or at least approach, the same operating performances of the crane for the displacement of a load, i.e. to preserve a fluid/dynamic piloting of the crane.

In other words, the shared actuators 61, 62 (or 63, 64) are associated with two movements which, in general, are never performed simultaneously, but successively.

Advantageously, the proposed piloting system 1 allows associating two distinct displacement movements that a crane 100; 200 can perform when it is working, and therefore associating the two work actuators 61, 62 (or 63, 64) each responsible for one of the two movements, with one single common variable-speed drive 41 (or 42).

For example, the hoisting, steering, and dispensing movements are generally forbidden during a translational movement. Indeed, piloting of a crane 100; 200 is most often done in two dimensions: vertically to hoist the load; and according to a horizontal plane to dispense and steer the jib 105; 205 to displace the load in the work area of the crane 100; 200. This is why the translational movement could be grouped with each of these three movements. In other words, in different embodiments, one amongst the two shared actuators 61, 62; 63, 64 may correspond to a translational actuator associated with a translational movement MT, whereas the other shared actuator 61, 62; 63, 64 may for example correspond to a hoisting actuator, or a steering actuator.

Jib cranes 100 integrate at least these three actuator types as well as a dispensing actuator associated with a dispensing movement MD. In two different embodiments, referred to later on respectively as the first and second configurations, it is possible, for this crane type, to group together the four displacement movements (and therefore the four actuators implementing them) into two groups by means of the common variable-speed drive 41 and the other common variable-speed drive 42.

The two configurations are established according to a tradeoff between:
operational performance objectives, for example in terms of speed or weight of loads that could be hoisted and displaced; and
safety objectives, in particular for limiting the risks of overload and for controlling dangling of the jib crane 100 during the displacement of the load. The actual performances of the control-command system 3 may also be considered.

The first configuration, illustrated in FIG. 5, pertains to an application context of minimizing the risks of overload and poor control of dangling even if it means that the functional performances of the jib crane 100 are not exploited to their full, and in which:
the first variable-speed drive 41, or common variable-speed drive, is connected to the first work actuator 61 and to the second work actuator 62 via the first distribution relay 51, where the first work actuator 61 is the hoisting actuator and the second work actuator 62 is the steering actuator; and
the second variable-speed drive 42, or other common variable-speed drive, is connected to the third work actuator 63 and to the fourth work actuator 64 via the second distribution relay 52, where the third work actuator 63 is the translational actuator and the fourth work actuator 64 is the dispensing actuator.

Thus, in this first configuration, in the event of a momentary overload and/or swinging of the load during the displacement of the latter, the crane operator is still mastering the piloting of the jib crane 100, by being capable of bringing the dispensing winch towards the mast 102 while lowering the load vertically, as he can act simultaneously on the dispensing actuator (herein fourth work actuator 64) and on the hoisting actuator (herein the first work actuator 61).

The second configuration, illustrated in FIG. 6, pertains to the context where the operational performances of the jib crane 100 are favored, with the crane operator being capable of piloting until reaching the operating limits authorized by safety standards, and in which:
the first variable-speed drive 41, or common variable-speed drive, is connected to the first work actuator 61 and to the second work actuator 62 via the first distribution relay 51, where the first work actuator 61 is the hoisting actuator and the second work actuator 62 is the dispensing actuator; and
the second variable-speed drive 42, or other common variable-speed drive, is connected to the third work actuator 63 and to the fourth work actuator 64 via the second distribution relay 52, where he third work actuator 63 is the translational actuator and the fourth work actuator 64 is the steering actuator.

Thus, in this second configuration, the crane operator can displace a load in the horizontal plane whose weight is equal to the limit imposed by the manufacturer of the crane and authorized by the torque/moment limiter, as he can act simultaneously on the steering actuator (herein the fourth work actuator 64) and on the dispensing actuator (herein the second work actuator 62).

It should be noted that in the examples of FIGS. 5 and 6, the translational actuator may be absent and, in this case, the dispensing actuator is connected alone to the second variable-speed drive 42 without the second distribution relay 52 (case of FIG. 5), or the steering actuator is connected alone to the second variable-speed drive 42 without the second distribution relay 52 (case of FIG. 6).

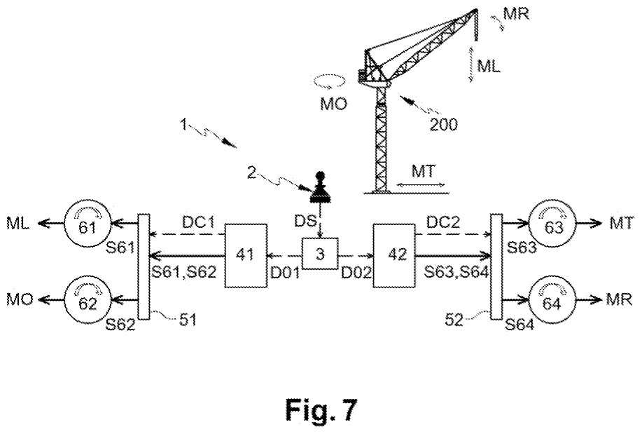

Referring to FIG. 7, the luffing crane 200 integrates a translational actuator (optional), a hoisting actuator, a steering actuator, and also as set out hereinbefore a jib luffing actuator. By means of this jib luffing actuator, the jib 205 may be luffed (respectively lowered) to hoist the load (respectively lower the load) and bring it close to (respectively away from) the mast 202. Consequently, when piloting a luffing crane 200, the crane operator should compensate for the rise or descent of the load, by means of the hoisting actuator, upon inclination of the jib 205 to change the dispense radius.

The hoisting, steering and luffing translational movements may be grouped together into two groups of displacement movements such that, on the one hand, the hoisting actuator and the steering actuator are shared and, on the other hand, the jib luffing actuator and the translational actuator are shared; in other words:
the first variable-speed drive 41, or common variable-speed drive, is connected to the first work actuator 61 and to the second work actuator 62 via the first distribution relay 51, where the first work actuator 61 is the hoisting actuator and the second work actuator 62 is the steering actuator; and
the second variable-speed drive 42, or the other common variable-speed drive, is connected to the third work actuator 63 and to the fourth work actuator 64 via the second distribution relay 52, where the third work actuator 63 is the translational actuator and the fourth work actuator 64 is the jib luffing actuator.

Thus, in this configuration illustrated in FIG. 7, a good tradeoff is offered in terms of operational performances and safety, because the crane operator is capable of adjusting the load by simultaneously performing a hoisting movement ML and a luffing movement MR, since he can simultaneously act on the hoisting actuator (herein the first work actuator 61) and on the jib luffing actuator (herein the fourth work actuator 64), and therefore the crane operator can pilot in the horizontal plane by combining these two movements MR, ML.

Possibly, in the case where the weight of the load is close to the load limit imposed by the manufacturer of the luffing crane 200, and in order to safeguard piloting of the latter, it may be considered, in a variant of the present embodiments, to connect the hoisting actuator and the jib luffing actuator together to a common variable-speed drive 41, and therefore group together the two most aggravating/risky movements MR, ML.

It should be noted that in the example of FIG. 7, the translational actuator may be absent, and in this case, the jib luffing actuator is connected alone to the second variable-speed drive 42 in the second distribution relay 52.

1-11. (canceled)

12. A piloting system for piloting a crane in work, the piloting system comprising at least:
a piloting interface configured to enable a crane operator to pilot displacement movements of a load by the crane;
a control-command system connected to the piloting interface configured to receive piloting signals originating from the piloting interface and generate piloting commands according to the piloting signals;
work actuators for implementing the displacement movements of the load; and
variable-speed drives connected to the control-command system and to the work actuators and configured to receive the piloting commands originating from the control-command system and transmit to the work actuators speed setpoints according to the piloting commands,
wherein at least one of the variable-speed drives is a first common variable-speed drive, and at least two of the work actuators are shared actuators, and
wherein the at least one first common variable-speed drive is connected to the at least two shared actuators via a distribution relay, the distribution relay being piloted so as to alternately connect the at least one first common variable-speed drive with each of the at least two shared actuators, so that the at least two shared actuators function alternately.

13. The piloting system according to claim 12, wherein the distribution relay is piloted by the at least one first common variable-speed drive which is configured to send to the distribution relay distribution setpoints according to the piloting commands originating from the control-command system.

14. The piloting system according to claim 12, wherein the control-command system is configured to transmit to the piloting interface an alert message for the crane operator when the crane operator acts on the piloting interface in order to pilot two movements at the same time associated to shared actuators that can function only alternately.

15. The piloting system according to claim 12, wherein the work actuators comprise a hoisting actuator associated with a hoisting movement, a steering actuator associated with a steering movement and a dispensing actuator associated with a dispense movement for the crane, and the at least two shared actuators comprise the hoisting actuator and the steering actuator in a first configuration, or the at least two shared actuators comprise the hoisting actuator and the dispensing actuator in a second configuration.

16. The piloting system according to claim 15, wherein the variable-speed drives include a second common variable-speed drive distinct from the at least one first common variable-speed drive, and the dispensing actuator is connected to the second common variable-speed drive in the first configuration, or
the steering actuator is connected to the second common variable-speed drive in the second configuration.

17. The piloting system according to claim 16, wherein:
in the first configuration: the second common variable-speed drive is connected to a translational actuator associated with a translational movement and to the dispensing actuator via another distribution relay, the other distribution relay being piloted so as to alternately connect the second common variable-speed drive with the translational actuator and the dispensing actuator, so that the translational actuator and the dispensing actuator function alternately; or
in the second configuration: the second common variable-speed drive is connected to a translational actuator associated with a translational movement and to the steering actuator via another distribution relay, the other distribution relay being piloted so as to alternately connect the second common variable-speed drive with the translational actuator and the steering actuator, so that the translational actuator and the steering actuator function alternately.

18. The piloting system according to claim 12, wherein the crane is a jib crane and the work actuators comprise a hoisting actuator associated with a hoisting movement, a steering actuator associated with a steering movement and a jib luffing actuator associated with a jib luffing movement for the crane, and the at least two shared actuators comprise the hoisting actuator and the steering actuator.

19. The piloting system according to claim 18, wherein the jib luffing actuator is connected to a second common variable-speed drive, amongst the variable-speed drives, distinct from the first common variable-speed drive.

20. The piloting system according to claim 19, wherein the second common variable-speed drive is connected to a translational actuator associated with a translational movement and to the jib luffing actuator via another distribution relay, the other distribution relay being piloted so as to alternately connect the second common variable-speed drive with the translational actuator and the jib luffing actuator, so that the translational actuator and the jib luffing actuator function alternately.

21. A crane comprising a piloting system according to claim 12.

22. A piloting method for piloting a crane in work, the method comprising at least:
a piloting step in which a crane operator pilots displacement movements of a load by the crane on a piloting interface;
a step of receiving piloting signals originating from the piloting interface by a control-command system connected to the piloting interface;
a step of generating by the control-command system piloting commands according to the piloting signals;
a step of transmitting the piloting commands to variable-speed drives which are connected to the control-command system and to work actuators for implementing the displacement movements of the load; and
a control step in which the variable-speed drives transmit to the work actuators speed setpoints according to the piloting commands,
wherein at least one of the variable-speed drives is a common variable-speed drive, and at least two of the work actuators are shared actuators,
wherein the at least one common variable-speed drive is connected to the at least two shared actuators via a distribution relay, and
wherein the piloting method further includes a switching step in which the distribution relay is piloted so as to alternately connect the at least one common variable-speed drive with each of the at least two shared actuators, so that the at least two shared actuators function alternately.
